(19) United States
(12) Patent Application Publication
(10) Pub. No.: US 2010/0266331 A1
(43) Pub. Date: Oct. 21, 2010

(54) Retention assembly and a method of operatively securing a hub and wheel assembly to an axle of a selectively movable assembly and method for eliminating frictional interface wear between a bearing and a bearing retention device

(76) Inventor: Steven Douglas Peterkort, Hawthorn Woods, IL (US)

Correspondence Address: John G. Chupa;Law Offices of John Chupa and Associates, P.C., 28535 Orchard Lake Rd., Suite 50, Farmington Hills, MI, 48334, US

(21) Appl. No.: 12/386,546

(22) Filed: Apr. 20, 2009

(51) Int. Cl. F16D 1/12; B60B 27/06; B23P 11/00

(52) U.S. Cl. 403/26; 301/110; 29/525.11

(57) ABSTRACT

A hub and wheel retention assembly 10 which securely and operatively retains a hub on an axle 16. The assembly includes a tapered bearing assembly 24 through which the axle 16 passes, and the bearing assembly 24 including an integrated nut portion 32 which is selectively coupled to the axle 16. The assembly 10 further includes an internally tabbed washer 50 which is selectively coupled to the axle 16 and prevents axial movement of the assembly 10 and secures the hub 18 to the axle 16, preventing outboard axial movement of the entire hub and wheel assembly 18.

### GENERAL BACKGROUND

1. Field of the Invention

The present invention generally relates to a retention assembly, and more particularly to a hub and wheel retention assembly received by an axle of a selectively movable assembly, such as, by way of example and without limitation, a vehicle, a truck or an automobile or a trailer, and which operatively secures an end portion of the axle within a wheel, to a method for operatively securing a hub and wheel assembly to an axle of a selectively movable assembly and to a method for eliminating frictional interface wear between a bearing and bearing retention device.

2. Background of the Invention

A selectively movable assembly, such as by way of example and without limitation a vehicle, a truck, an automobile or a trailer, typically has several axle assemblies. Each axle assembly has respective and opposed hub and wheel ends or retention assemblies which must be respectively, operatively and securely retained to and within a wheel. Moreover, the wheel must be free to selectively rotate while the axle is selectively positioned and retained within the hub and wheel. The selective rotation of the hub and wheel ends about the axle, of course, causes and allows the selectively movable vehicle to move. While strategies and techniques do exist which allow the hub and wheel ends to be respectively and operatively secured to, and rotate about the axle, the contained and secured hub and wheel ends do relatively often become dislodged from their relative position on the axle and the selectively movable assembly. This “wheel-off” occurrence often causes significant and serious damage to the vehicle, and often personal injury to its occupants and bystanders, as well as damage to other vehicles and assemblies.

There is therefore a need for a new and improved hub and wheel retention assembly and to a new and improved method for operatively adjusting and then securing a hub and wheel assembly to an axle, which reduces the incidence of failures associated with current assemblies. There is also a need for a new and improved strategy which improves upon the reliability of existing and prior strategies and which accomplishes these objectives in a relatively cost effective manner. The present invention(s) address these and other needs which may be discerned from a reading of this Application, including the claims.

### SUMMARY OF THE INVENTION

It is a first non-limiting objective of the present invention to provide a new and improved hub and wheel retention assembly which overcomes some or all of the previously delineated disadvantages of prior and current assemblies, such as by way of example and without limitation, those which are delineated above.

It is a second non-limiting objective of the present invention to provide a new and improved hub and wheel retention strategy or methodology which overcomes some or all of the previously delineated disadvantages of prior and current strategies, such and by way of example and without limitation, those which are delineated above and elsewhere in this description.

It is a third non-limiting objective to provide a new and improved bearing adjustability strategy.

It is fourth non-limiting objective to provide a new and improved method for reducing frictional wear between a bearing and a bearing surface.

According to a first non-limiting aspect of the present invention, a retention assembly is provided and includes a bearing assembly; a nut which is integrally formed with the bearing assembly; a washer; and a plurality of fasteners which respectively and cooperatively attach the washer to the integrated nut and bearing.

According to a second non-limiting aspect of the present invention, a hub and wheel retention assembly which securely retains the hub and wheel to the axle having a threaded portion is provided. Particularly, the hub and wheel retention assembly includes a bearing assembly comprising an outer race portion and an inner race portion which receives the axle of a selectively movable vehicle, wherein the bearing assembly further includes a plurality of roller bearings which movably contact the outer race portion of the bearing assembly and an inner cup portion of the hub all of which move in response to the movement of the selectively movable vehicle and wherein the inner race portion of the retention device also includes an integral nut portion which also receives the threaded portion of the axle; an outer washer; and a plurality of fasteners which cooperatively couple the washer to the nut portion, wherein the bearing and nut assembly, the washer, and the plurality of fasteners cooperatively secure the hub and wheel to the axle at a certain location.

According to a third non-limiting aspect of the invention a method is provided. Particularly, the method comprises A method of operatively securing an axle of a selectively movable vehicle within a hub and wheel, said method comprising the steps of obtaining a bearing assembly of the type having a plurality of tapered rollers which movably contact said race portion and which move about said axle and wherein said race portion also includes an integral formed nut; placing said axle within said nut portion while placing said plurality of tapered rollers in contact with an inner bearing cup portion of said hub and wheel; obtaining a tabbed washer; and coupling said washer to said nut and integral bearing which secures said hub and wheel to the axle and within said hub and wheel.

According to a fourth non-limiting aspect of the invention, a method is provided for effectively eliminating a frictional interface wear surface between a bearing and a bearing retention device. The method comprises the steps of forming a bearing and integral nut portion.

According to a fifth non-limiting embodiment these and other features, aspects and advantages of this present invention will become apparent to those of ordinary skill in the art by reference to the following detailed description in the preferred embodiment of the invention, including the subjoined claims, and by reference to the following drawings.

### BRIEF DESCRIPTION OF THE DRAWINGS

FIG. 1 is a side view of a selectively movable assembly incorporating a hub and wheel retention assembly which is made in accordance with the teachings of the present inventions.

FIG. 2 is a side view of a portion of the hub and wheel retention assembly which is made in accordance with the teachings of the present invention and which is shown, for example, in FIG. 1.

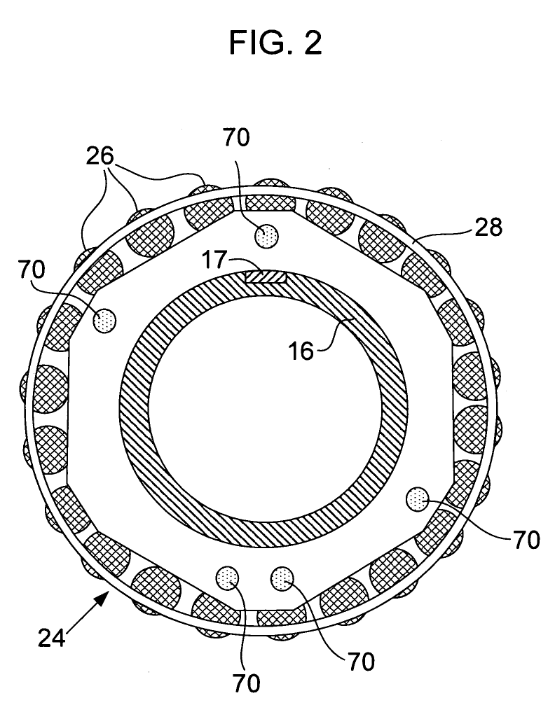

FIG. 3 is a cross sectional view of the hub and wheel retention assembly which is shown in FIGS. 1 and 2.

FIG. 4 is a cross sectional view of the hub and wheel retention assembly which is shown in FIGS. 1, 2, and 3 and which is further shown assembled to a wheel hub and axle of a selectively movable vehicle.

FIG. 5 is a side view of the washer portion of the hub and wheel retention assembly which is shown in FIGS. 1 and 4.

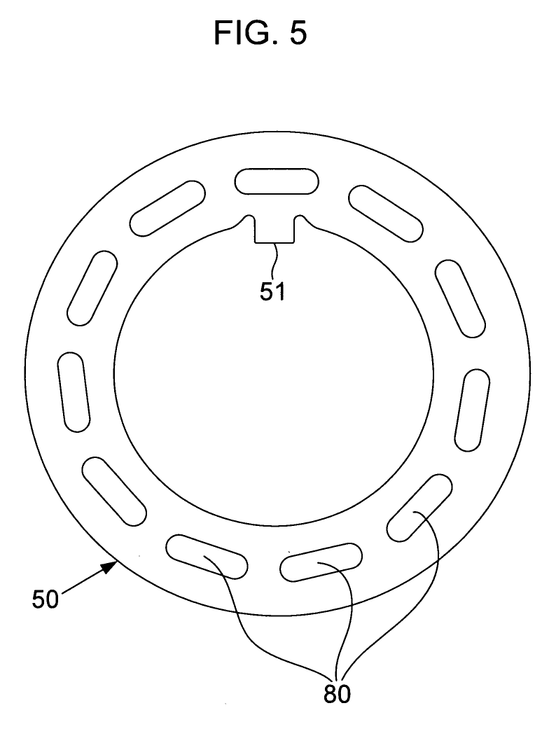

### DETAILED DESCRIPTION OF THE PREFERRED EMBODIMENTS OF THE INVENTION

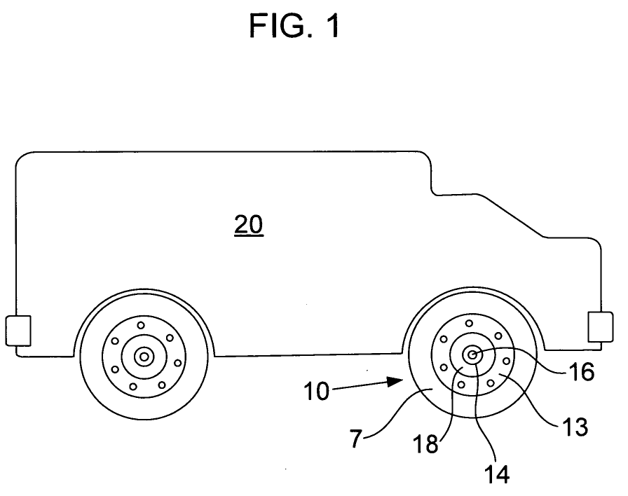

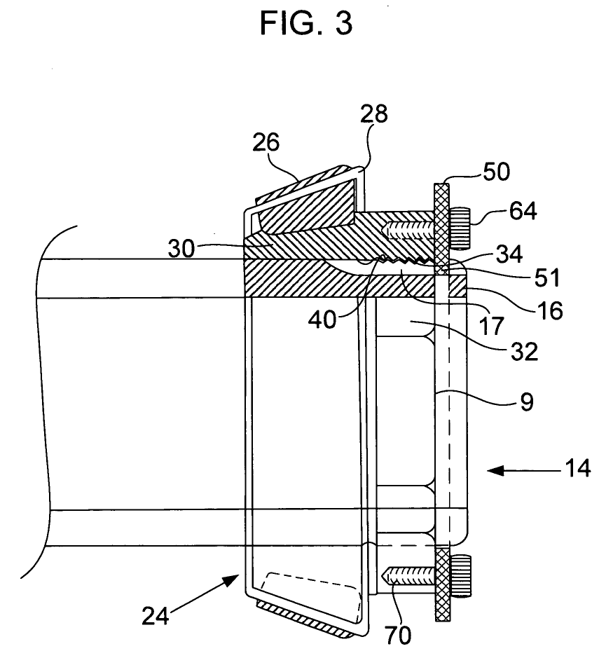

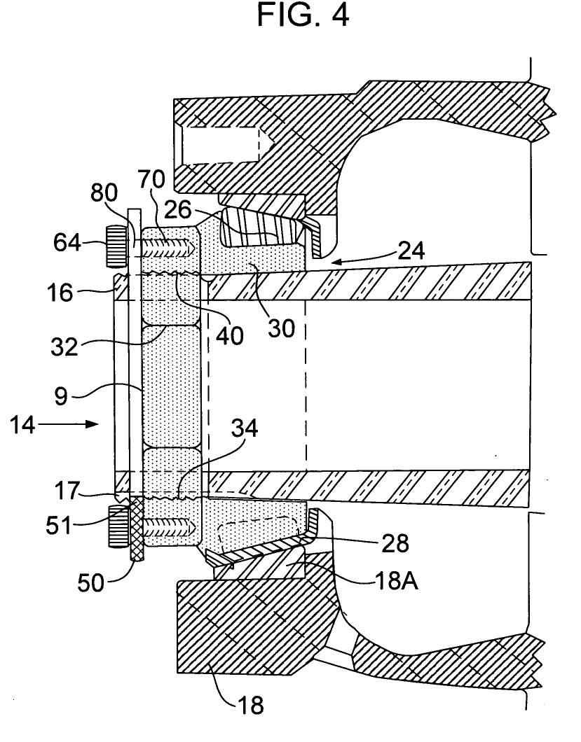

Referring now to FIGS. 1, 3, and 4 there is shown a hub and wheel retention assembly 10 which is made in accordance with the teachings of the preferred embodiment of the invention and which is adapted to selectively retain a wheel hub 18 to an end portion 14 of an axle 16 of a selectively movable vehicle 20. The hub 18 is operatively contained with a wheel 13 and a tire 7 is operatively disposed upon the wheel 13. It should be appreciated that there is nothing in this description which limits the selectively movable vehicle 20 to a particular type of selectively movable assembly. Rather, the vehicle 20 may comprise an automobile, a truck, a trailer or substantially any other type of selectively movable assembly, and the term “selectively movable assembly” is to be interpreted as generally referring to any type of assembly which moves, whether under its own power or not, in a selected manner.

It should be further appreciated that a selectively movable vehicle, such as selectively movable vehicle 20, may have several axles, such as axle 16. In the preferred embodiment, each respective end of each respective axle of a selectively movable vehicle should be received by a unique one of the retention assemblies 10, and each retention assembly 10 is respectively and operatively contained within a unique wheel hub 18. Thus, while the following discussion focuses upon the single retention assembly 10, it should be understood that substantially identical retention assemblies should be similarly and respectively and operatively deployed upon each unique axle end portion and contained within unique hubs of unique wheels of the selectively movable assembly 20. The following discussion of assembly 10 applies to and is similar to the description of each of the other required assemblies which are operatively contained within vehicle 20.

Assembly 10 includes a tapered bearing assembly 24 which has a plurality of spaced apart bearing rollers (such as, by way of example and without limitation, tapered roller bearings) 26 which are operatively contained within a bearing cage 28. The assembly 24 further includes an inner race 30 and a nut potion 32 which is integrally formed with the inner race 30. By way of example and without limitation, assembly 24 and nut portion 32 may be created in a single forging operation, by machining, or by substantially any other desired operation. Because inner race 30 and nut portion 32 are integrally formed there is no relative movement between inner race 30 and nut portion 32. In the most preferred, although non-limiting embodiment, the race 30 and portion 32 are formed from the same material.

In one non-limiting embodiment of the invention, the nut portion 32 has threads 34 which are complimentary to the threads 40 which are present upon the end portion 14 of the axle 16. The Term “complementary” means threads 34 may selectively engage threads 40 and such engagement allows the assembly 10 to be selectively and operatively and removably and fixedly disposed upon the axle 16. In this manner, the axle end portion 16 is received by and traverses the tapered bearing assembly 24 and is received by and traverses the inner race 30 before operatively residing in the nut portion 32.

The complementary nature of the threads 34, 40, allows the nut portion 32 to be selectively and mechanically secured to the axle end portion 16 while still allowing the tapered rollers 26 to rotate within and about the race portion 30 and within the cage 28 and also within a retention cup 18A within the wheel hub 18. That is, the threaded nut portion 32 is secured to the axle 16 while the movable bearing portions (e.g., tapered rollers 26, which are movably, fixedly, and operatively contained, within the cage 28), rotate about the inner race portion 30 and move within the bearing cup 18A of the hub 18, thus allowing the forces (whether they be acceleration or deceleration forces) of the selectively movable vehicle 20 to be imparted freely to the bearing contained within hub 18 (not shown). Descriptions of one non-limiting embodiment of such a hub may be found within www.auto.howstuffworks.com, after the term “wheel hub” is placed within the “search field”. This description is fully and completely incorporated herein by reference, and one such description is found at http://auto.howstuffworks.com/auto/parts/towing/equipment/acces sories/trailer-wheels-hubsl.htm.

The assembly 10 further includes a washer portion or member 50 which selectively overlays the nut portion 32 and is attached to the nut portion 32 by use of a plurality of threaded and substantially identical fastener members 64. In one non-limiting embodiment, holes, such as hole 70, are tapped or formed within nut portion 32 and actually extend into the race portion 30 of the bearing assembly portion 24. The washer member 50 includes a plurality of elongated holes or slots, such as hole 80. When assembled, at least two of the slots or holes 80 are made or formed within the washer 50 and spaced apart. Each slot or hole 80 respectfully aligns with (i.e., is made to selectively align with) and communicates with a unique hole 70. Each pair of communicating holes 70, 80, cooperatively and respectively receives a unique threaded fastener member 64, thereby coupling the washer 50 to the nut 32. In this manner the assembly 10 secures the wheel hub 18 to the axle portion 16.

Furthermore, in the most preferred although non-limiting embodiment, the member 50 also has a protruding and inner locking tab 51 which is designed to align with and selectively fit inside of a milled slot 17 that is present in the outboard end 14 of the axle 16. This feature allows the washer member 50 to be installed on the axle 16 and it allows the washer member 50 to fit flush against the outboard end or surface of the nut portion 32, while the slots or holes 80 selectively and respectively align with the plurality of threaded holes 70 in the nut portion 32, as previously described. The term “outboard end” or “surface” reference to the surface 9 of the nut portion 32 which receives and contacts the washer 50.

Once the threaded fastener members 64 are respectively installed in their respective and mating holes 70, the entire assembly 10 is now securely and operatively installed to the axle 16. Moreover, it should be realized that the washer member 50 cannot rotate about the axle 16 because the tab of the washer 51 is first aligned and then fitted to the slot 17 of the axle 16, thus positively inhibiting it from rotational movement. The washer 50 is also as described, fitted flush against the outer bearing face 9 of the nut portion 32 and the slots or holes 80 of the washer 50 are now each aligned with a unique one of plurality of corresponding holes of the nut 70 and are positively received by a plurality of threaded members 64, thus securing washer 50 to axle 16 and washer 50 to nut 32 and to the entire hub and wheel retention assembly 10.

This arrangement positively secures the washer 50 to the nut 32 and to the axle 16 and completely and positively prevents both axial movement of the entire assembly 10 (the term “axial movement” means movement in the axial or longitudinal direction of axle 16) and also prevents torsional or rotational movement of the washer 50 and the nut portion 32 and the inner race portion 30, while allowing the bearing portion 24 (and its components, the tapered rollers 26), to freely rotate about the inner race 30, within the cage 28 and within the bearing cup 18A (into which hub 18 resides), thus allowing the forces (whether they be acceleration or deceleration forces) of the selectively movable vehicle 20 to freely move upon or be imparted to the hub bearings 26. Hub 18 may have additional bearings (not shown) is other non-limiting embodiments.

It should be appreciated that the “one piece” or integral bearing assembly 24 and nut portion 32 provide enhanced strength and security to the assembly and to the retention of the hub assembly 18 to the axle 16. While many other retention systems do exist today, all systems employ a separate bearing assembly that is retained by a separate nut and washer or retainer system of various designs and styles. However, each and every nut and/or retainer system in use today, which Applicant is aware, all have a frictional interface surface between the outer face of the race of the bearing assembly and the opposing inner bearing surface of the nut or retainer. That is, there exist two distinct surfaces (the bearing face surface and the nut surface which come into contact when the nut is installed on the bearing) It should be appreciated that this “movable” interface between the bearing and the nut creates wear or frictional degradation that causes the bearing face to wear and/or the nut or retainer face to wear thus causing increased “end-play” or movement in the axle and/or bearing and/or retainer and/or seal systems. Furthermore this wear often results in the premature degradation of the seals of the hub 18, which in turn leads to the loss of bearing lubricant. Furthermore, the loss of bearing lubricant often causes the premature wear and ultimate failure of the hub bearings and of the retaining nut and washer which in turn can create serious maintenance problems and in the worst case, a catastrophic “wheel-off” failure, causing serious damage to the vehicle, and often serious personal injury to its occupants and bystanders, as well as damage to other vehicles.

In the current embodiment, the frictional interface surface is eliminated by virtue of the previously described integrated, one-piece design, (i.e., there is no relative movement between the nut 32 and inner race 30) whether by use of forging or machining, which effectively creates a one-piece bearing assembly and retaining nut design. It should be appreciated that the elimination of a frictional interface surface effectively eliminates the wear of the hub bearings, and the wear of the nut and the resulting undesirable increase in “end play”, and eliminates the degradation of the seal(s), and subsequent loss of bearing lubricant, and the premature failure of the bearing and retaining nut, thus providing enhanced safety and security to the hub retention system of the selectively movable vehicle 20.

Further, by selectively placing a plurality of holes 70 within the nut portion 32 and extending these holes into the inner bearing race portion 30 of the integrated assembly, a plurality of fasteners 64 can be received and a more secure overall connection and retention is achieved. The holes 70 may be symmetrically or asymmetrically placed or formed upon the face 9 of the nut 32 depending upon the design and without limitation, and the number of holes 70 can vary, again depending upon the design and without limitation, thus offering a multitude of hole 70 and fastener 64 alignment possibilities, again achieving a more secure connection and retention.

Further, the elongated nature of the slots and/or holes 80, can vary in the number of slots and in their respective size and shape depending upon the design. These holes 80, in the outer washer 50 provide a multitude of corresponding relative alignments to the receiving holes 70 in the nut portion 32 and in the bearing race portion 30 of the opposing nut and bearing system. The combination of receiving nut holes 70, which are aligned with slots 80 in the mating washer 50, and the multitude of fasteners 64 will again achieve a more secure overall connection and retention of the hub 18 to the axle 16. Again, the number of holes 70 in the nut 32 and slots 80 in the washer 50 and fasteners 64 that are ultimately received and/or utilized may vary, again depending upon the design. By the foregoing, it shall be evident that assembly 10 retains the hub 18 and wheel 13 to the axle 16.

Lastly, the significant feature of bearing adjustability must be addressed in the current non-limiting embodiment and as it relates to traditional nut retention systems in use today. The application and purpose of any hub retention system has two significant criteria; first—safe, robust securement and retention of the hub/wheel to the axle; and second—accuracy of bearing “end-play” adjustment, which when properly adjusted, assures seal integrity, longer bearing life and security of the entire hub and wheel assembly.

There are many traditional systems to adjust bearings and secure hubs in use but all of these traditional systems require a final desired bearing adjustment, again one key to seal and bearing life and hub retention integrity, which does not allow a final locking mechanism to be engaged. Therefore the traditional hub retaining system must either be torsionally rotated clockwise or counterclockwise (with respect to the axle) in order to align the final locking element, a feature which varies widely in the various applications in use today. The result of this required rotation, in either direction, negatively effects the bearing adjustment yielding an undesirable and excessive amount of end play or an undesirable and excessive amount of bearing preload. In either circumstance, excessive bearing end play or excessive bearing preload can compromise the life of the bearing assembly and/or the seal, thus causing premature failure, which in a worst-case scenario can lead to a catastrophic failure of the entire hub and wheel securement.

There is therefore a need for a new and improved strategy and method to achieve proper adjustment of the bearing without the need to rotate or otherwise move the nut in either direction in order to engage a final locking and securement feature or element of the device, and which accomplishes these methods in a relatively cost effective manner.

In the present invention(s), the plurality of receiving threaded holes 70(which are formed in the nut portion 32 and extend into the race portion 30) cooperate with the elongated slots/holes 80 in the outboard and final washer member 50 resulting in a final alignment of the locking washer 50 to the nut 32, which effectively eliminates the need for any secondary or tertiary rotational movement of the bearing adjustment nut 32 to align and engage the final threaded fasteners 64, thus completing the proper and secure installation of the present invention, an integral bearing/nut, hub and wheel adjustment and retention device 10. The only rotation that is needed is the initial rotation of the nut portion 32 upon the axle 16 before the washer 50 was installed.

It is to be understood that the inventions are not limited to the exact construction or method which has been illustrated and described above, but that various changes and modifications may be made without departing from the spirit and the scope of the inventions as may be defined in the following claims.

What is claimed is:

1) A retention assembly comprising a bearing assembly; a nut which is integrally formed with said bearing assembly; a washer; and a plurality of fasteners which respectively and cooperatively attach said washer to said integral nut and bearing assembly.

2) A hub and wheel aspect of the present invention, a hub and wheel retention assembly which securely retains the hub and wheel to the axle having a threaded portion is provided. Particularly, the hub and wheel retention assembly includes a bearing assembly comprising an outer race portion and an inner race portion which receives the axle of a selectively movable vehicle, wherein the bearing assembly further includes a plurality of roller bearings which movably contact the outer race portion of the bearing assembly and an inner cup portion of the hub all of which move in response to the movement of the selectively movable vehicle and wherein the inner race portion of the retention device also includes an integral nut portion which also receives the threaded portion of the axle; an outer washer; and a plurality of fasteners which cooperatively couple the washer to the nut portion, wherein the bearing and nut assembly, the washer, and the plurality of fasteners cooperatively secure the hub and wheel to the axle at a certain location.

3) A method of operatively securing an axle of a selectively movable vehicle within a hub and wheel, said method comprising the steps of obtaining a bearing assembly of the type having a plurality of tapered rollers which movably contact said race portion and which move about said axle and wherein said race portion also includes an integral formed nut; placing said axle within said nut portion while placing said plurality of tapered rollers in contact with an inner bearing cup portion of said hub and wheel; obtaining a tabbed washer; and coupling said washer to said nut and integral bearing which secures said hub and wheel to the axle and within said hub and wheel.

4) A method of effectively eliminating a frictional interface wear surface between a bearing and a bearing retention device, by forming or machining a bearing and integral nut that effectively eliminates traditional inner and outer components, by means of unitizing the bearing assembly and the outer nut in one piece.

5) A method of achieving a final desired and precise adjustment and location of a bearing and an alignment of an outer retention washer and securing said washer to an integrated bearing and nut device without having to move, or otherwise rotate the integrated bearing and nut device.
